(19) United States
(12) Patent Application Publication
(10) Pub. No.: US 2014/0087019 A1
(43) Pub. Date: Mar. 27, 2014

(54) READY TO EAT SEAFOOD SAUSAGES AND SEAFOOD BALLS

(71) Applicant: Alice Chang, South Pasadena, CA (US)

(72) Inventor: Alice Chang, South Pasadena, CA (US)

(21) Appl. No.: 13/864,134

(22) Filed: Apr. 16, 2013

Related U.S. Application Data
(60) Provisional application No. 61/704,441, filed on Sep. 21, 2012.

(51) Int. Cl. A23L 1/325

(52) U.S. Cl. CPC A23L 1/3257
USPC 426/2; 426/105; 426/92; 426/283

(57) ABSTRACT

A ready to eat seafood sausages and seafood balls comestible includes ingredients combined in proportions substantially including: seafood; casing; and seasoning(s). The seafood is cooked to make the seafood sausage. The casing has a hollow interior for holding the seafood and the seasonings in combination. The ready to eat seafood sausages and seafood balls comestible is prepared by intermixing the seafood, and the seasonings, when prepared are cooked and inserted into the casing, the ready to eat seafood sausages and seafood balls comestible being high in nutrition, including protein, vitamins, and minerals, and have less cholesterol than red meat and suitable for readily consuming.

### CROSS-REFERENCE TO RELATED APPLICATION

The present application is related to and claims priority from prior provisional application Ser. No. 61/704,441, filed Sep. 21, 2012 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of comestibles and more specifically relates to ready to eat seafood sausages and seafood balls.

2. Description of the Related Art

The majority of people desire a healthy lifestyle; however many individuals do not feel that they have time to cook healthy meals in modern society. Due to rushed schedules many individuals eat unhealthy foods that may lead to obesity and other serious health problems. Many foods such as seafood are healthier than red meats for example; however seafood may not typically come in a form that is readily conducive to easy preparation.

Seafood is generally any form of sea life regarded as food by humans. Seafood prominently includes fish and shellfish in most societies. Shellfish include various species of molluscs, crustaceans, and echinoderms. Seafood is consumed all over the world; it provides the worlds prime source of high-quality protein: 14-16% of the animal protein consumed world-wide; over one billion people rely on seafood as their primary source of animal protein. Fish is among the most common food eaten. Research over the past few decades has shown that the nutrients and minerals in seafood can make improvements in brain development and reproduction and has highlighted the role for seafood in the functionality of the human body. A more efficient and convenient option is needed to provide seafood for user consumption on a regular basis.

Various attempts have been made to solve the above-mentioned problems such as those found in U.S. Pat. and Pub. Nos. 2,687,356; 3,532,512; 2008/0241331; 7,867,536; 2002/0090427; 2006/0222747; 4,309,450; and 4,622,234. This art is representative of seafood comestibles. None of the above inventions and patents, taken either singly or in combination, is seen to describe the invention as claimed.

Ideally, ready to eat seafood sausages and seafood balls should provide a nutritional seafood comestible that is convenient to prepare and desirable to eat and, yet would be able to be processed and manufactured at a modest expense. Thus, a need exists for healthy ready to eat seafood sausages and seafood balls to avoid the above-mentioned problems.

### BRIEF SUMMARY OF THE INVENTION

In view of the foregoing disadvantages inherent in the known seafood comestibles art, the present invention provides novel ready to eat seafood sausages and seafood balls. The general purpose of the present invention, which will be described subsequently in greater detail is to provide a nutritional seafood comestible that is convenient to prepare and desirable to eat.

The purpose of the present invention is to create ready to eat sausages and balls with seafood. The invention is to provide people shopping for food the convenience of getting processed seafood sausages and seafood balls, and people who eat at fast food restaurants the choice of seafood sausages and seafood balls. Seafood sausages and seafood balls can contain ground or minced seafood such as shrimp, crab, clam, oyster, scallop, lobster, abalone, conch, octopus, squid, jellyfish, cuttlefish, fish roe, shrimp roe, fish, prawn, krill, mussel, sea cucumber, sea urchin, sea eel, freshwater eel, land snail, sea snail and freshwater snail or the like and combinations thereof. Seafood sausages and seafood balls can contain a single seafood such as shrimp, to make shrimp sausages and shrimp balls; or a combination of seafood such as jellyfish and squid, to make jellyfish and squid sausages and balls. The sausages and balls may come in casings or be produced without casings. On the other hand, the sausages and balls can have an outer coating instead of the casing, or they can have no outer coating. The food is easy to prepare and healthy to eat.

Ready to eat seafood sausages and seafood balls comestible is disclosed herein comprising ingredients combined in proportions substantially including: at least one seafood; at least one casing; and at least one seasoning. The at least one seafood is cooked to make the seafood sausage. The ready to eat seafood sausages and seafood balls comestible is prepared by intermixing the at least one seafood, and the seasonings, when prepared are cooked and inserted into the casing, the ready to eat seafood sausages and seafood balls comestible being high in nutrition, including protein, vitamins, and minerals, and less cholesterol than red meat and suitable for readily consuming.

The seafood is first ground up. The seafood(s) are selected from the group consisting of shrimp, crab, clam, oyster, scallop, lobster, abalone, conch, octopus, squid, jellyfish, cuttlefish, fish roe, shrimp roe, fish, prawn, krill, mussel, sea cucumber, sea urchin, sea eel, freshwater eel, land snail, sea snail and freshwater snail and includes at least one seafood or a combination of two or more seafood(s).

The at least one seasoning is selected from the group consisting of salt, pepper, onion, garlic, ginger, curry, chili, vinegar, lemon, lime, peppermint, basil, thyme, parsley, rosemary, soup stock and broth. Other seasonings used may include clove, cinnamon, coriander, cumin, shallots. The cooking means when cooked are selected from the group consisting of deep frying, grilling, boiling, baking, and steaming. The seafood sausages and seafood balls are served in combination with at least one garnish, the garnish(es) are selected from the group consisting of lettuce, onions, tomatoes, pickles, and cheese. Further, the seafood sausages and seafood balls may be served in combination with and selected from the group consisting of bread buns, potatoes, rice, and pasta. Also, the seafood sausages and seafood balls are served in combination with at least one condiment, the condiment(s) are selected from the group consisting of mustard, mayonnaise, ketchup, and relish.

The seafood preferably comprises a casing. The casing (or holding means) comprises a hollow interior for holding at least one seafood and seasonings in combination. And it is selected from the group consisting of gelatin, cleaned intestine, collagen, and cellulose. Additionally, the casing comprises a tube comprising a diameter of approximately ½ to about 2 inches, and a length of about 2 to 8 inches in preferred embodiments. On the other hand, an outer coating can be used. The outer coating when used is selected from the group consisting of bread crumbs, beer batter, egg batter, and cornmeal batter.

A method of preparing ready to eat seafood sausages and seafood balls is also disclosed herein comprising the steps of: washing the seafood; removing bones, shells, and internal organs from the seafood when necessary; grinding the seafood into an even and smooth texture creating varying shapes and sizes; seasoning the seafood; inserting the seafood(s) into casings; cooking the seafood as sausage (or ball form); garnishing the sausage with a bun and condiments; serving the ready to eat seafood sausages and seafood balls as hot food in restaurants, the ready to eat seafood sausages and seafood balls comestibles are packaged into air tight containers to preserve freshness until ready for consumption; and consuming the sausage as seafood sausage (or ball form).

The present invention holds significant improvements and serves as ready to eat seafood sausages and seafood balls. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready to eat seafood sausages and seafood balls, constructed and operative according to the teachings of the present invention.

FIG. 1A shows a perspective view illustrating ready to eat seafood sausages according to an embodiment of the present invention.

FIG. 1B shows a perspective view illustrating ready to eat seafood balls according to an embodiment of the present invention.

FIG. 2 is a perspective view illustrating the ready to eat seafood sausages and seafood balls comestibles as used to make embodiments of the present invention of FIG. 1.

FIG. 3 is a flowchart illustrating a method of preparing the ready to eat seafood sausages and seafood balls comestibles according to an embodiment of the present invention of FIGS. 1-2.

The various embodiments of the present invention will hereinafter be described in conjunction with the appended drawings, wherein like designations denote like elements.

### DETAILED DESCRIPTION

As discussed above, embodiments of the present invention relate to comestibles and more particularly to ready to eat seafood sausages and seafood balls as used to improve the convenience of preparing and eating of (including) seafood in an individual's diet and thus the overall health of the consumer.

Generally speaking, the purpose, as previously mentioned, is to create healthy comestibles; sausages and balls comprising seafood to provide people shopping for food the convenience of getting processed seafood sausages and seafood balls, and people who eat at fast food restaurants the choice of seafood sausages and seafood balls.

Seafood sausages and seafood balls can contain grinded or minced seafood such as shrimp, crab, clam, oyster, scallop, lobster, abalone, conch, octopus, squid, jellyfish, cuttlefish, fish roe, shrimp roe, fish, prawn, krill, mussel, sea cucumber, sea urchin, sea eel, freshwater eel, land snail, sea snail and freshwater snail and the like within a casing, which can be made by an elongated tube-like thin layer of gelatin, or a spherical shaped thin layer of gelatin, in small and large sizes. The tube like casing can range from about ½ inch in diameter to about 2 inches in diameter, and a length of about 2 inches to 8 inches. The spherical shaped casing can range from about 1 to 2 inches in diameter. Other shapes and sizes may be used, such as cubical shape and cylindrical shape. Other types of casing can also be used, such as cleaned intestine, collagen, and cellulose to make the present invention.

After the seafood is ground or minced, other ingredients that are ground, minced, semi-solid, or liquid, can be added and mixed with the seafood. The other ingredients include egg, meat, vegetable, herb, fruit, cereal, nut, bean, cheese, butter, and so on. On the other hand, the ground or minced seafood can wrap around the other ingredients that are ground, minced, semi-solid, or liquid, so that the other ingredients are in the core. The ground or minced seafood that are mixed in with the other ingredients can also be used to wrap around the other ingredients, which are to form the core of the seafood sausages and seafood balls.

Seafood sausages and seafood balls can contain a single seafood such as shrimp, to make shrimp sausages and shrimp balls; or a combination of seafood such as jellyfish and squid to make jellyfish and squid sausages and balls. The seafood sausages and seafood balls can be purchased pre-cooked and seasoned, and ready to eat with bread buns, potatoes, rice, pasta, etc. The seafood sausages and seafood balls (when not pre-cooked) may be cooked by deep frying, grilling, boiling, baking, etc., and they can be seasoned with salt, pepper, onion, garlic, ginger, curry, chili, vinegar, lemon, lime, peppermint, basil, thyme, parsley, rosemary, soup stock and broth, clove, cinnamon, coriander, cumin, shallots. For example at fast food restaurants, the seafood sausages and seafood balls can be deep fried and placed inside a sliced bread roll, and can be served with lettuce, onions, tomatoes, pickles, cheese, and condiments such as mustard, mayonnaise, ketchup, and relish. Further, the seafood balls may be served as an appetizer. The seafood sausages and seafood balls can have no outer layer or an outer layer of bread crumbs or batter, such as beer batter, egg batter, or cornmeal batter, can be added before frying. The seafood sausages and seafood balls can be packaged into air tight containers. It should be noted that the outer coating can be used instead of the casing, and the outer coating is suitable for both the seafood sausage and the seafood balls. The containers can be made of paper, plastic, glass, metal.

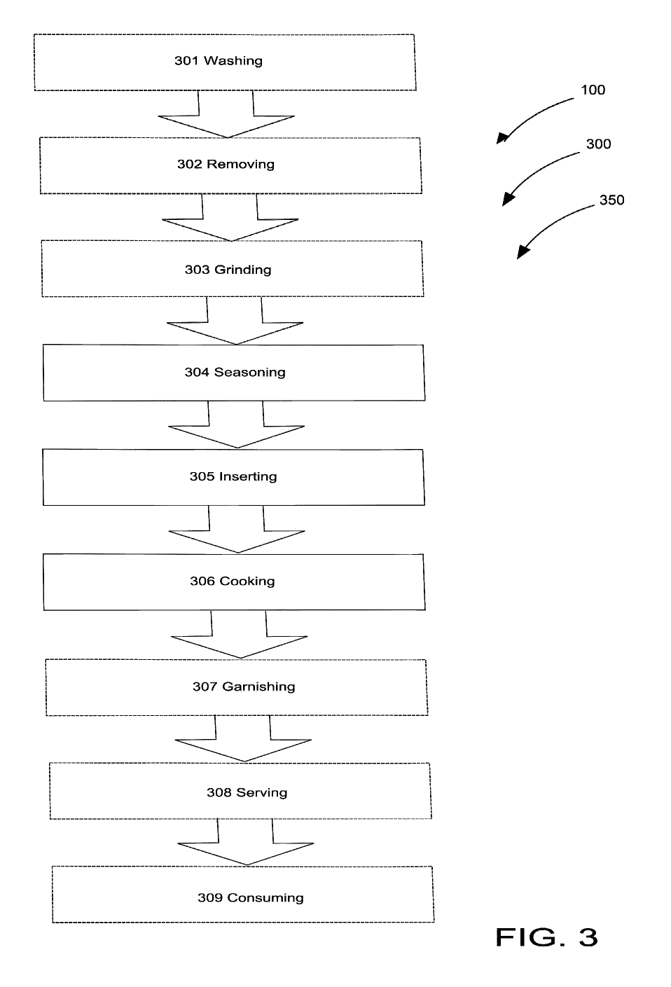

Making of the seafood sausages and seafood balls as discussed in further detail in FIG. 3 includes washing; removal of bones, shells, and internal organs; grinding; seasoning; casing; cooking and seasoning. As such the processed seafood sausages and seafood balls save people time and energy to obtain seafood as a meal. Seafood provides a good source of nutrition, including protein, vitamins and minerals, and less cholesterol than red meat.

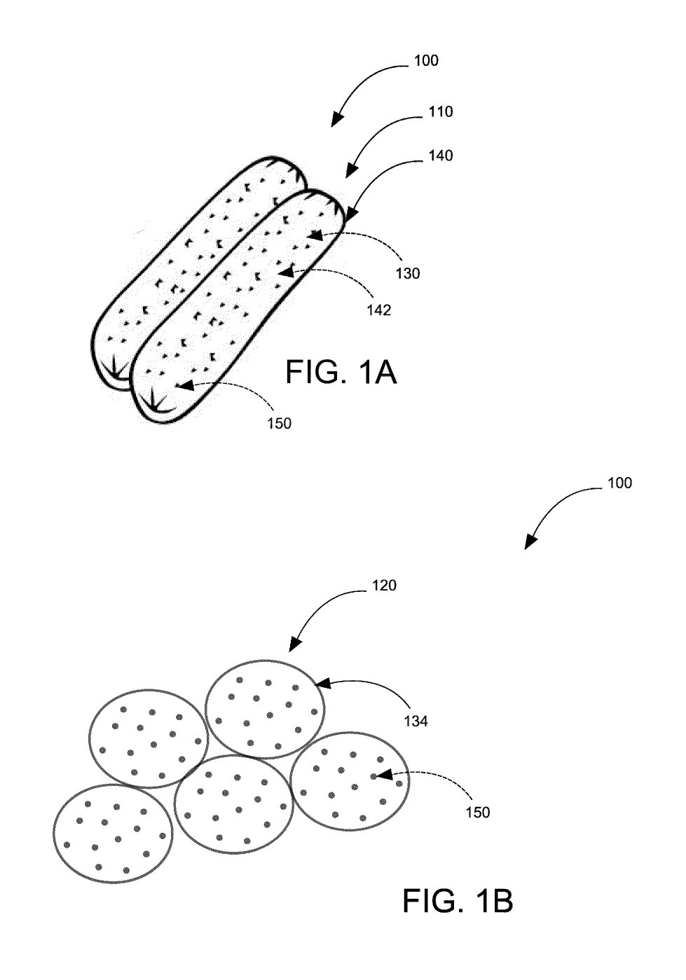

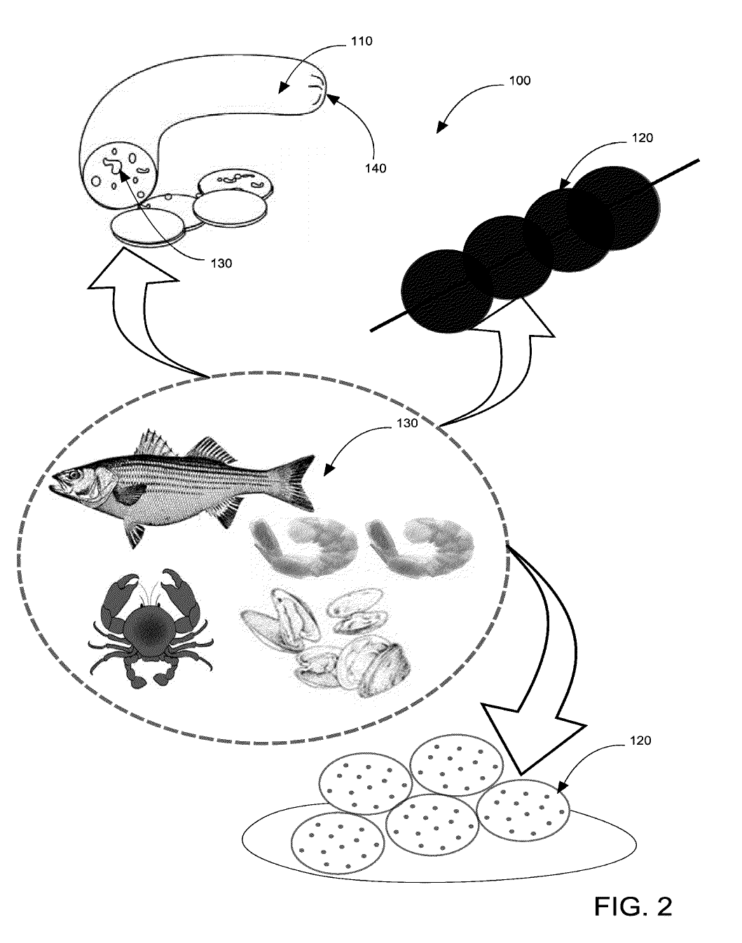

Referring now more specifically to the drawings by numerals of reference there is shown in FIGS. 1A-2 showing perspective views illustrating ready to eat seafood sausages 110 and seafood balls 120 (once prepared to be eaten), to be prepared both according to embodiments of the present invention.

Ready to eat seafood sausages 110 and seafood balls 120 comestible 100 comprises ingredients combined in proportions substantially including: at least one seafood 130; at least one casing 140 (optional but preferred); and at least one seasoning 150. At least one seafood 130 is preferably cooked to make seafood sausage 110. Ready to eat seafood sausages 110 and seafood balls 120 comestible is prepared by intermixing the at least one seafood 130, and seasoning 150, and when prepared are cooked and inserted into casing 140; ready to eat seafood sausages 110 and seafood balls 120 comestible 100 being high in nutrition, including protein, vitamins, and minerals, and less cholesterol than red meat and suitable for readily consuming. The present invention serves as a healthy substitute for red meat and pork sausages.

The cooking means (when pre-cooked or cooked at home) are selected from the group consisting of deep frying, grilling, boiling, baking, and steaming. Seafood 130 may be ground up or minced. Seafood(s) 130 are selected from the group consisting of shrimp, crab, clam, oyster, scallop, lobster, abalone, conch, octopus, squid, jellyfish, cuttlefish, fish roe, shrimp roe, fish, prawn, krill, mussel, sea cucumber, sea urchin, sea eel, freshwater eel, land snail, sea snail and freshwater snail and includes at least one seafood, or a combination of two or more seafood(s) 130, as previously mentioned. Many other seafood and combinations thereof may be envisioned to be used and still be considered within the scope of the present invention.

At least one seasoning 150 is selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, shallots. Seafood sausages 110 and seafood balls 120 are served in combination with at least one garnish; the garnish(es) are selected from the group consisting of lettuce, onions, tomatoes, pickles, and cheese. Further, seafood sausages 110 and seafood balls 120 are served in combination with and selected from the group consisting of bread buns, potatoes, rice, and pasta. Also, seafood sausages 110 and seafood balls 120 are served in combination with at least one condiment, the condiment(s) are selected from the group consisting of mustard, mayonnaise, ketchup, and relish, as desired.

Seafood 130 comprises outer coating 134 as formed seafood balls 120 to maintain the desired shape. Outer coating 134 (when used) is selected from the group consisting of bread crumbs, beer batter, egg batter, and cornmeal batter. Casing 140 preferably comprises hollow interior 142 for holding the at least one seafood 130 and seasonings 150 in combination. Casing 140 (or holding means when used) is selected from the group consisting of gelatin, cleaned intestine, collagen, and cellulose. Additionally, casing 140 may comprises a tube comprising a diameter of approximately ½ to about 2 inches, and a length of about 2 to 8-inches. Casing 140 may also be spherical in shape and comprises a diameter of approximately 1 to 2 inches. Further, casing 140 may also be cuboidal in shape. It should be noted that casing 140 is not limited to the shapes and sizes described and other suitable shapes and dimension may be used for casing 140. It should be noted that the outer coating 134 can be used instead of casing 140, and outer coating 134 is suitable for both the seafood sausages 110 and seafood balls 120.

Ready to eat seafood sausages 110 and seafood balls 120 can be packaged into air tight containers to preserve freshness until ready to serve. The containers can be made of paper, plastic, glass, metal. In this way the present invention may be easily shipped and stored.

Referring now to FIG. 3, flowchart 350 illustrating a method of preparing 300 ready to eat seafood sausages 110 and seafood balls 120, according to embodiments of the present invention of FIGS. 1A-2.

Method of preparing 300 ready to eat seafood sausages 110 and seafood balls 120 comprises the steps of: step one 301 washing seafood 130; step two 302 removing bones, shells, and internal organs from seafood 130 (when necessary); step three 303 grinding seafood 130 into an even and smooth texture creating varying shapes and sizes; step four 304 seasoning seafood 130; step five 305 inserting seafood 130 into casings 140; step six 306 cooking seafood 130 as sausage 110; step seven 307 garnishing seafood sausage 110 with a bun and condiments; step eight 308 serving said ready to eat seafood sausages and seafood balls as hot food in restaurants, said ready to eat seafood sausages and seafood balls comestibles are packaged into air tight containers to preserve freshness until ready for consumption; and step nine 309 consuming the sausage as seafood sausage 110. Optional steps are in dashed boxes in FIG. 3.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready to eat seafood sausages and seafood balls comestible comprising ingredients combined in proportions substantially including:
at least one seafood;
at least one casing;
at least one seasoning;
wherein said at least one seafood is cooked to make said seafood sausage;
wherein said casing comprises a hollow interior for holding said at least one seafood and said at least one seasoning in combination; and
wherein said ready to eat seafood sausages and seafood balls comestible is prepared by intermixing said at least one seafood, and said at least one seasoning, when prepared are cooked and inserted into said casing, said ready to eat seafood sausages and seafood balls comestible being high in nutrition, including protein, vitamins, and minerals, and less cholesterol than red meat and suitable for readily consuming.

2. The ready to eat seafood sausages and seafood balls comestible system of claim 1 wherein said seafood is ground up.

3. The ready to eat seafood sausages and seafood balls comestible of claim 1 wherein said seafood is minced.

4. The ready to eat seafood sausages and seafood balls comestible of claim 1 wherein said seafood comprises no outer coating as formed said seafood balls.

5. The ready to eat seafood sausages and seafood balls comestible of claim 1 wherein said seafood comprises an outer coating as formed said seafood balls.

6. The ready to eat seafood sausages and seafood balls comestible of claim 5 wherein said outer coating is selected from the group consisting of bread crumbs, beer batter, egg batter, and cornmeal batter.

7. The ready to eat seafood sausages and seafood balls comestible of claim 1 wherein said casing is selected from the group consisting of gelatin, cleaned intestine, collagen, and cellulose.

8. The ready to eat seafood sausages and seafood balls comestible of claim 7 wherein said casing comprises a tube comprising a diameter of approximately ½ to about 2-inches, and a length of about 2 to 8-inches.

9. The ready to eat seafood sausages and seafood balls comestible of claim 7 wherein said casing is spherical in shape and comprises a diameter of approximately 1 to 2 inches.

10. The ready to eat seafood sausages and seafood balls comestible of claim 7 wherein said casing is cuboidal in shape.

11. The ready to eat seafood sausages and seafood balls comestible of claim 1 wherein said cooking means when cooked are selected from the group consisting of deep frying, grilling, boiling, baking, and steaming.

12. The ready to eat seafood sausages and seafood balls comestible of claim 1 wherein said at least one seafood(s) are selected from the group consisting of shrimp, crab, clam, oyster, scallop, lobster, abalone, conch, octopus, squid, jellyfish, cuttlefish, fish roe, shrimp roe, fish, prawn, krill, mussel, sea cucumber, sea urchin, sea eel, freshwater eel, land snail, sea snail and freshwater snail.

13. The ready to eat seafood sausages and seafood balls comestible of claim 12 wherein said seafood(s) includes at least 2 combinations of said seafood(s).

14. The ready to eat seafood sausages and seafood balls comestible of claim 1 wherein said at least one seasoning is selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, shallots.

15. The ready to eat seafood sausages and seafood balls comestible of claim 1 wherein said seafood sausages and said seafood balls are served in combination with at least one garnish, said garnish(es) are selected from the group consisting of lettuce, onions, tomatoes, pickles, and cheese.

16. The ready to eat seafood sausages and seafood balls comestible of claim 1 wherein said seafood sausages and said seafood balls are served in combination with and selected from the group consisting of bread buns, potatoes, rice, and pasta.

17. The ready to eat seafood sausages and seafood balls comestible of claim 1 wherein said seafood sausages and said seafood balls are served in combination with at least one condiment, said condiment(s) are selected from the group consisting of mustard, mayonnaise, ketchup, and relish.

18. A ready to eat seafood sausages and seafood balls comestible comprising ingredients combined in proportions substantially including:
at least one seafood;
at least one casing; and
at least one seasoning;
wherein said ready to eat seafood sausages and seafood balls comestible is prepared by intermixing said at least one seafood, and said at least one seasoning, when prepared are cooked and inserted into said casing, said ready to eat seafood sausages and seafood balls comestible being high in nutrition, including protein, vitamins, and minerals, and less cholesterol than red meat and suitable for readily consuming;
wherein said at least one seafood is cooked to make said seafood sausage;
wherein said seafood is ground up;
wherein said seafood(s) includes at least 2 combinations of said seafood(s);
wherein said seafood comprises an outer coating as formed said seafood balls;
wherein said outer coating is selected from the group consisting of bread crumbs, beer batter, egg batter, and cornmeal batter;
wherein said casing is selected from the group consisting of gelatin, cleaned intestine, collagen, and cellulose;
wherein said casing comprises a tube comprising a diameter of approximately ½ to about 2-inches, and a length of about 2 to 8-inches;
wherein said cooking means when cooked are selected from the group consisting of deep frying, grilling, boiling, baking, and steaming;
wherein said at least one seafood(s) are selected from the group consisting of shrimp, crab, clam, oyster, scallop, lobster, abalone, conch, octopus, squid, jellyfish, cuttlefish, fish roe, shrimp roe, fish, prawn, krill, mussel, sea cucumber, sea urchin, sea eel, freshwater eel, land snail, sea snail and freshwater snail;
wherein said seafood(s) includes at least 2 combinations of said seafood(s);
wherein said at least one seasoning is selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, shallots;
wherein said seafood sausages and said seafood balls are served in combination with at least one garnish, said garnish(es) are selected from the group consisting of lettuce, onions, tomatoes, pickles, and cheese;
wherein said seafood sausages and said seafood balls are served in combination with and selected from the group consisting of bread buns, potatoes, rice, and pasta; and
wherein said seafood sausages and said seafood balls are served in combination with at least one condiment, said condiment(s) are selected from the group consisting of mustard, mayonnaise, ketchup, and relish.

19. A method of preparing ready to eat seafood sausages and seafood balls comprising the steps of:
washing seafood;
removing bones, shells, and internal organs from said seafood when necessary;
grinding said seafood into an even and smooth texture creating varying shapes and sizes;
seasoning said seafood;
inserting said seafood into casings;
cooking said seafood as sausage;
garnishing said sausage with a bun and condiments; and
serving said ready to eat seafood sausages and seafood balls as hot food in restaurants, said ready to eat seafood sausages and seafood balls comestibles are packaged into air tight containers to preserve freshness until ready for consumption.

20. The method of claim 19 further comprising the step of consuming said sausage as seafood sausage.
